(19) United States
(12) Patent Application Publication
(10) Pub. No.: US 2014/0199655 A1
(43) Pub. Date: Jul. 17, 2014

(54) DENTAL TRAP

(71) Applicant: Dennis E. Metzger, New Haven, IN (US)

(72) Inventor: Dennis E. Metzger, New Haven, IN (US)

(21) Appl. No.: 14/156,090

(22) Filed: Jan. 15, 2014

Related U.S. Application Data
(60) Provisional application No. 61/753,640, filed on Jan. 17, 2013.

(51) Int. Cl. A61C 5/14

(52) U.S. Cl. CPC A61C 5/14
USPC 433/136; 433/215

(57) ABSTRACT

A dental trap is provided for use in a mouth cavity of a patient during a dental procedure. The dental trap may separate the patient's mouth cavity from the patient's throat to prevent an extracted tooth and/or a dental tool, such as a screw, in the mouth cavity from falling into the throat. The dental trap may also allow the patient to breathe through the dental trap.

### CROSS REFERENCE TO RELATED APPLICATION

This application claims priority to U.S. Provisional Patent Application Ser. No. 61/753,640, filed Jan. 17, 2013, the disclosure of which is hereby expressly incorporated by reference herein in its entirety.

### FIELD OF THE DISCLOSURE

The present disclosure relates to a dental apparatus and method. More particularly, the present disclosure relates to a dental trap, and to a method for using the same.

### BACKGROUND OF THE DISCLOSURE

During a dental procedure, such as a tooth extraction, a dentist may place gauze into a patient's throat. The gauze may block off the patient's throat, preventing the patient from swallowing an extracted tooth or a dental tool, such as a screw. However, the gauze may make breathing and swallowing difficult for the patient and may cause the patient discomfort. Also, the gauze may trigger the patient's pharyngeal or gag reflex.

### SUMMARY

The present disclosure provides a dental trap for use in a mouth cavity of a patient during a dental procedure. The dental trap may separate the patient's mouth cavity from the patient's throat to prevent an extracted tooth and/or a dental tool, such as a screw, in the mouth cavity from falling into the throat. The dental trap may also allow the patient to breathe through the dental trap.

According to an embodiment of the present disclosure, a dental trap is provided for use in a patient. The patient has a mouth cavity in communication with a throat. The dental trap includes an inner body having an anterior surface that faces outward from the mouth cavity of the patient and a posterior surface that faces inward toward the throat of the patient, and an outer rim around the inner body, the outer rim being sized and shaped to mate with the patient inside the mouth cavity to separate the mouth cavity of the patient from the throat of the patient.

According to another embodiment of the present disclosure, a dental trap is provided for use in a patient. The patient has a mouth cavity with teeth and a throat. The dental trap includes a generally elliptical or circular body that is sized and shaped to fit inside the mouth cavity of the patient at a location behind teeth of the patient and in front of the throat of the patient, the body having an anterior surface that faces outward from the mouth cavity of the patient and a posterior surface that faces inward toward the throat of the patient.

According to yet another embodiment of the present disclosure, a method is provided for performing a dental procedure on a patient. The patient has a mouth cavity with teeth and a throat. The method includes the step of placing a dental trap inside the mouth cavity of the patient to separate the mouth cavity of the patient from the throat of the patient, the dental trap including an inner body and an outer rim around the inner body.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is an anterior view of a mouth cavity of a patient;

FIG. 2 is an anterior view of the mouth cavity of FIG. 1, also including an exemplary dental trap of the present disclosure inside the mouth cavity;

FIG. 3 is an anterior view of the dental trap of FIG. 2 shown outside of the mouth cavity;

FIG. 4 is a cross-sectional view of the dental trap of FIG. 3, taken along line 4-4 of FIG. 3; and

FIG. 5 is an anterior view of another exemplary dental trap of the present disclosure.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

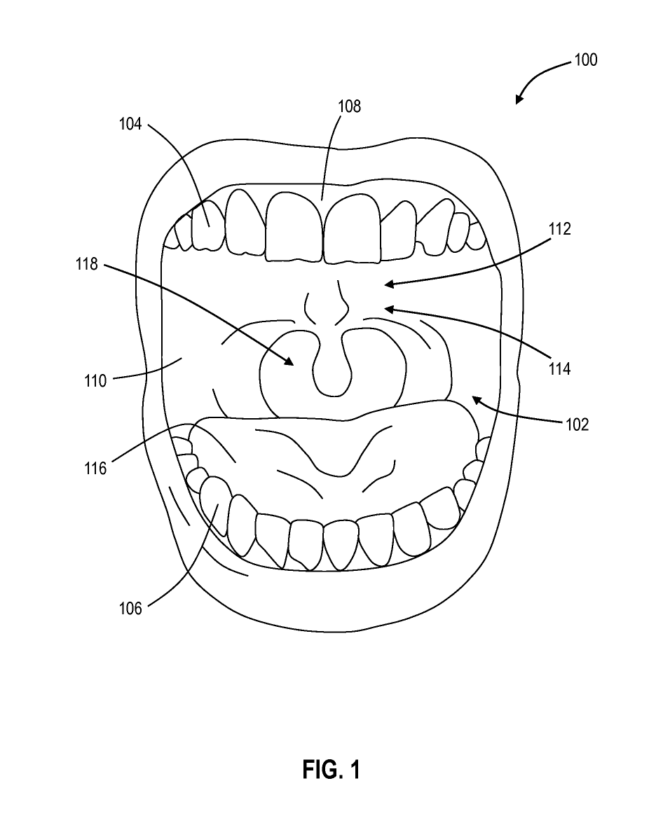

A mouth cavity 102 of a patient 100 is shown in FIG. 1. Mouth cavity 102 of patient 100 is bounded anteriorly (i.e., in front) and laterally (i.e., side-to-side) by teeth, specifically by a row of upper teeth 104 attached to the maxilla or upper jaw (not shown) of patient 100 and a row of lower teeth 106 attached to the mandible or lower jaw (not shown) of patient 100, and also by gums 108 and cheeks 110 of patient 100. Mouth cavity 102 of patient 100 is bounded superiorly (i.e., on top) by a hard palate region 112 and a soft palate region 114 located posteriorly of (i.e., behind) the hard palate region 112. Soft palate region 114 may also be referred to as the velum or the muscular palate. Mouth cavity 102 of patient 100 is bounded inferiorly (i.e., on bottom) by a tongue 116 primarily.

Mouth cavity 102 of patient 100 is open posteriorly (i.e., in back) to a throat 118. Throat 118 includes the pharynx (not shown) which communicates with both the esophagus (not shown) for digestion and with the larynx (not shown) for respiration. Thus, mouth cavity 102 provides a passageway to throat 118 for both digestion and respiration.

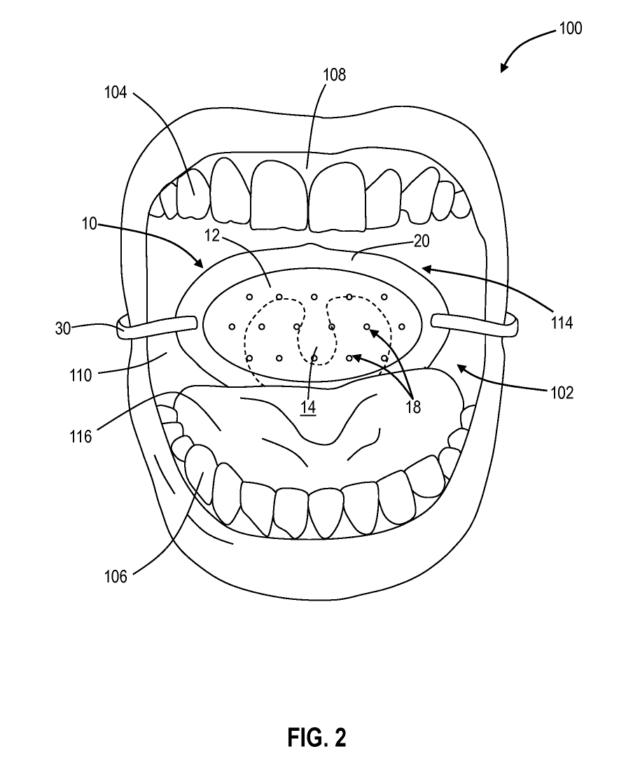

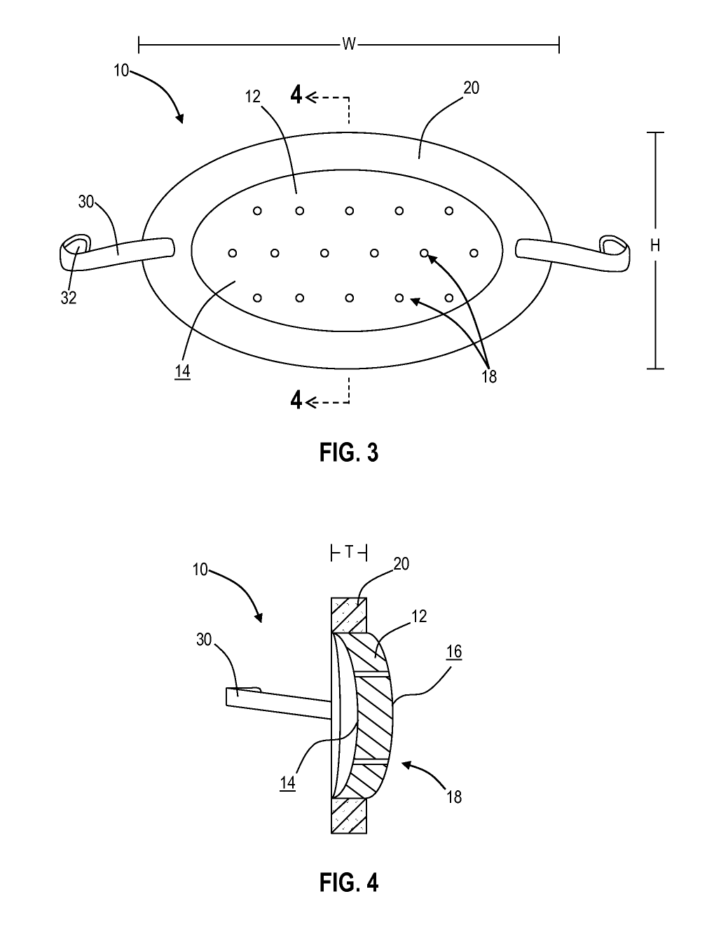

An exemplary dental trap 10 of the present disclosure is shown inside mouth cavity 102 of patient 100 in FIG. 2, and is shown outside of mouth cavity 102 of patient 100 in FIGS. 3 and 4. Dental trap 10 includes an inner body 12 with an anterior surface 14 and an opposing posterior surface 16. When dental trap 10 is positioned inside mouth cavity 102 of patient 100, as shown in FIG. 2, anterior surface 14 of dental trap 10 faces outward from mouth cavity 102 toward a dentist or a dental technician, while posterior surface 16 of dental trap 10 faces inward into mouth cavity 102 toward throat 118.

According to an exemplary embodiment of the present disclosure, and as shown in FIG. 4, anterior surface 14 of dental trap 10 is concave in shape. The concave shape of anterior surface 14 may maximize the space available in mouth cavity 102 for the dentist to perform dental procedures. The concave shape of anterior surface 14 may also leave all or a majority of the teeth 104, 106 exposed anteriorly of dental trap 10, as shown in FIG. 2, for the dentist to perform dental procedures. Posterior surface 16 of dental trap 10 may be convex in shape, as shown in FIG. 4, allowing inner body 12 to maintain a generally consistent thickness T between the concave anterior surface 14 and the convex posterior surface 16. The thickness T of dental trap 10 may be about 10 millimeters (mm), 8 mm, 6 mm, or less, for example.

Inner body 12 of dental trap 10 may be flexible in construction, allowing inner body 12 to move and change shape in mouth cavity 102. In this embodiment, inner body of dental trap 10 may be similar to a flexible sock or a flexible pocket Inner body 12 of dental trap 10 may also be rigid in construction. In this embodiment, inner body 12 of dental trap 10 may similar to a rigid cup or a rigid socket. Inner body 12 of dental trap 10 may be constructed of plastic, metal, fabric, mesh, netting, or another suitable biocompatible material, for example.

Dental trap 10 further includes an outer rim 20 that at least partially surrounds inner body 12. Outer rim 20 may be coupled to inner body 12 via a friction fit, an interlocking feature (e.g., interlocking tabs/grooves), adhesive, thread, one or more mechanical fasteners, or another suitable coupling mechanism. When dental trap 10 is positioned inside mouth cavity 102 of patient 100, as shown in FIG. 2, outer rim 20 of dental trap 10 may be sized and shaped to mate with patient 100 in a manner that separates, blocks off, or shields mouth cavity 102 from throat 118. For example, outer rim 20 of dental trap 10 may be sized and shaped to mate superiorly with soft palate region 114 and inferiorly with tongue 116 of patient 100. In this manner, dental trap 10 may prevent an extracted tooth and/or a dental tool, such as a screw, in mouth cavity 102 from falling into throat 118. Outer rim 20 of dental trap 10 may be generally elliptical in shape or circular in shape, for example.

Referring still to FIG. 2, dental trap 10 may be sized and shaped to fit behind teeth 104, 106. For example, outer rim 20 of dental trap 10 may be sized and shaped to mate superiorly with soft palate region 114 and inferiorly with tongue 116 at a location behind teeth 104, 106. In this embodiment, all or a majority of the teeth 104, 106 may remain exposed to the dentist anteriorly of dental trap 10, allowing the dentist to perform a dental operation on one or more teeth 104, 106 and/or gums 108.

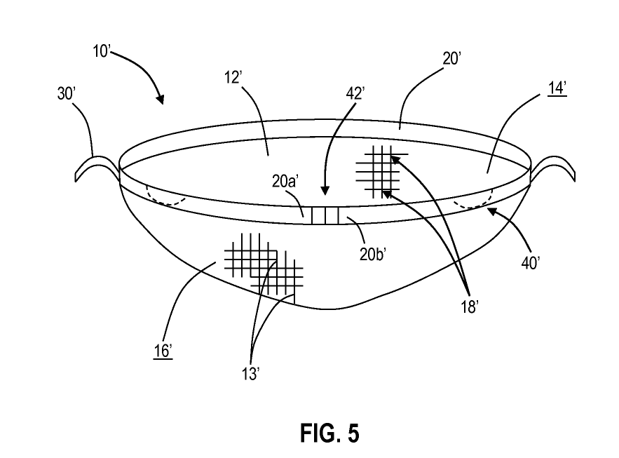

The size and shape of dental trap 10 may vary depending on the size and shape of the intended mouth cavity 102, the desired position of dental trap 10 inside mouth cavity 102, and other factors. For example, with reference to FIG. 3, the width W of dental trap 10 may be about 20 mm, 40 mm, 60 mm, 80 mm, or more, and the height H of dental trap 10 may be about 10 mm, 30 mm, 50 mm, 70 mm, or more. Dental trap 10 may be provided in smaller sizes to accommodate children and in larger sizes to accommodate adults. It is also within the scope of the present disclosure to provide a set of dental traps 10 of different shapes and sizes, allowing the dentist to select a desired dental trap 10 from the set to accommodate a particular patient 100. It is further within the scope of the present disclosure for each dental trap 10 to be adjustable in size, such that a single dental trap 10 may accommodate various patients 100. An adjustable dental trap 10 is described further below with reference to FIG. 5.

According to an exemplary embodiment of the present disclosure, outer rim 20 of dental trap 10 is flexible in construction and capable of changing shape. In this manner, outer rim 20 of dental trap 10 may conform to the inner contour of mouth cavity 102 of each particular patient 100 and form a seal with patient 100. Outer rim 20 of dental trap 10 may be constructed of foam, rubber, or another flexible material. When outer rim 20 of dental trap 10 is constructed of foam, for example, the foam may be biased outwardly to contact patient 100 and may be compressed inwardly in certain locations to match the inner contour of mouth cavity 102. The flexible construction of outer rim 20 may allow outer rim 20 to take on an irregular or custom, patient-specific contour to form a seal with patient 100. Additionally, the flexible construction of outer rim 20 may provide a soft, cushioned, comfortable surface for contact with patient 100.

Referring to FIG. 2, inner body 12 of dental trap 10 may include one or more breathing apertures 18 between anterior surface 14 and posterior surface 16. Even when outer rim 20 of dental trap 10 is sealed against patient 100 in mouth cavity 102, patient 100 may be able to breathe through inner body 12 of dental trap 10 via breathing apertures 18. Each breathing aperture 18 in dental trap 10 should be sized smaller than any extracted teeth and/or dental tools being used during the dental procedure, thereby allowing the passage of air through breathing apertures 18 while preventing any extracted teeth and/or dental tools from falling through breathing apertures 18 and into throat 118. For example, the size (e.g., diameter) of each breathing aperture 18 may be about 2 mm, 1 mm, 0.5 mm, or less. Breathing apertures 18 may be formed by piercing small holes in inner body 12 of dental trap 10, or by another suitable method.

Referring still to FIG. 2, dental trap 10 may further include one or more stoppers 30 that prevent dental trap 10 from lodging too deep into mouth cavity 102 of patient 100. Stoppers 30 may also assist the dentist in removing dental trap 10 from mouth cavity 102 of patient 100 after use. The illustrative right-side and left-side stoppers 30 are hook-shaped, although the shape and location of stoppers 30 may vary. When dental trap 10 is positioned inside mouth cavity 102 of patient 100, as shown in FIG. 2, the hook-shaped stoppers 30 extend anteriorly from outer rim 20 of dental trap 10, out of mouth cavity 102, and around the right and left cheeks 110 of patient 100. The interaction between stoppers 30 and cheeks 110 of patient 100 prevents dental trap 10 from lodging too deep into mouth cavity 102 of patient 100. Also, the dentist may pull on stoppers 30 to remove dental trap 10 from patient 100 after use. Stoppers 30 may be constructed of and/or covered with a flexible material, such as foam pads 32, to provide a soft, cushioned, comfortable surface for contact with patient 100.

A dentist or a dental technician may place dental trap 10 in mouth cavity 102 of patient 100 before beginning a dental procedure, as shown in FIG. 2. During the dental procedure, dental trap 10 may prevent an extracted tooth and/or a dental tool, such as a screw, in mouth cavity 102 from falling into throat 118 of patient 100 while allowing patient 100 to breathe through dental trap 10. After the dental procedure, dental trap 10 may be removed from mouth cavity 102 of patient and either discarded or sterilized for re-use.

Another exemplary dental trap 10′ of the present disclosure is shown in FIG. 5. Dental trap 10′ of FIG. 5 is similar to dental trap 10 of FIGS. 2-4, with like reference numerals indicating like elements.

Dental trap 10′ includes inner body 12′ with a plurality of interwoven strands 13′ that form a fabric, mesh, or netting, for example. Each strand 13′ of inner body 12′ may be constructed of metal, plastic, or another suitable material. Adjacent strands 13′ of inner body 12′ may be spaced apart to define breathing apertures or pores 18′ therebetween. In one embodiment, inner body 12′ is constructed of a breathable nylon fabric.

Dental trap 10′ also includes outer rim 20′. In the prior embodiment of FIG. 2, dental trap 10 was shown positioned at a relatively deep location inside mouth cavity 102 of patient 100 near throat 118. Outer rim 20 of dental trap 10 was shown mating superiorly with soft palate region 114 of patient 100 in this relatively deep location. Dental trap 10′ may also be positioned at a relatively shallow location inside mouth cavity 102 of patient 100 (FIG. 1). This shallow spacing may allow the dentist to operate on a tooth 104, 106 located at or in front of dental trap 10′, while positioning dental trap 10′ further in front of throat 118. This shallow spacing may be achieved by mating outer rim 20′ of dental trap 10′ with hard palate region 112 of patient 100, which is located anteriorly (i.e., forward) of soft palate region 114. In this relatively shallow location, outer rim 20′ of dental trap 10′ may contact one or more teeth 104, 106, especially one or more lower teeth 106. A plurality of removable (e.g., perforated) cut outs 40′ may be provided in outer rim 20′ to accommodate teeth 104, 106 therethrough, while still allowing outer rim 20′ to sealingly mate with patient 100. Cut outs 40′ allow the dentist to position dental trap 10′ as deep as necessary in each specific patient 100.

Outer rim 20′ of dental trap 10′ further includes at least one size adjustment mechanism 42′. In the illustrated embodiment of FIG. 5, the size adjustment mechanism 42′ includes a first part 20a′ of outer rim 20′ that is configured to slide relative to a second part 20b′ of outer rim 20′. The size adjustment mechanism 42′ allows the dentist to expand and retract outer rim 20′ in a manner similar to adjusting the size of a belt. When the desired size is achieved, first and second parts 20a′, 20b′ of outer rim 20′ may be secured together via a snap, a peg, or another suitable fastening mechanism.

Outer rim 20′ of dental trap 10′ further include one or more stoppers 30′. In the illustrated embodiment of FIG. 5, stoppers 30′ extend laterally from the right and left sides of outer rim 20′ and may be configured to engage teeth 104, 106 or cheeks 110 of patient 100 (FIG. 1).

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A dental trap for use in a patient, the patient having a mouth cavity in communication with a throat, the dental trap comprising:
an inner body having an anterior surface that faces outward from the mouth cavity of the patient and a posterior surface that faces inward toward the throat of the patient; and
an outer rim around the inner body, the outer rim being sized and shaped to mate with the patient inside the mouth cavity to separate the mouth cavity of the patient from the throat of the patient.

2. The dental trap of claim 1, wherein the anterior surface of the inner body is concave.

3. The dental trap of claim 1, wherein the inner body defines a plurality of breathing apertures between the anterior surface and the posterior surface.

4. The dental trap of claim 1, wherein the outer rim is constructed of a flexible material.

5. The dental trap of claim 4, wherein the outer rim is constructed of foam.

6. The dental trap of claim 1, wherein the outer rim is one of circular and elliptical in shape.

7. The dental trap of claim 1, further comprising at least one stopper that projects anteriorly from the dental trap to extend out of the mouth cavity of the patient.

8. The dental trap of claim 7, wherein the at least one stopper is hook-shaped to hook around the patient outside of the mouth cavity.

9. A dental trap for use in a patient, the patient having a mouth cavity with teeth and a throat, the dental trap comprising:
a generally elliptical or circular body that is sized and shaped to fit inside the mouth cavity of the patient at a location behind teeth of the patient and in front of the throat of the patient, the body having an anterior surface that faces outward from the mouth cavity of the patient and a posterior surface that faces inward toward the throat of the patient.

10. The dental trap of claim 9, wherein the body defines a plurality of breathing apertures between the anterior surface and the posterior surface.

11. The dental trap of claim 9, wherein the body includes an inner portion and an outer rim surrounding the inner portion.

12. The dental trap of claim 9, wherein the inner portion of the body includes a plurality of interwoven strands that cooperate to define breathing apertures.

13. The dental trap of claim 9, further comprising a first stopper located on a right side of the body and a second stopper located on a left side of the body, the first and second stoppers projecting at least one of anteriorly and laterally from the body.

14. The dental trap of claim 9, wherein the body is rigid.

15. The dental trap of claim 9, wherein at least a portion of the body is flexible.

16. A method of performing a dental procedure on a patient, the patient having a mouth cavity with teeth and a throat, the method comprising the step of:
placing a dental trap inside the mouth cavity of the patient to separate the mouth cavity of the patient from the throat of the patient, the dental trap including an inner body and an outer rim around the inner body.

17. The method of claim 16, wherein the placing step comprises placing the dental trap behind the teeth of the patient.

18. The method of claim 16, wherein the mouth cavity of the patient is bounded superiorly by a hard palate region and a soft palate region and inferiorly by a tongue, the method further comprising the step of sealing the dental trap superiorly against one of the hard palate region and the soft palate region and inferiorly against the tongue of the patient.

19. The method of claim 16, further comprising the step of changing the shape of the dental trap to conform to an inner contour of the mouth cavity of the patient.

20. The method of claim 16, further comprising the step of abutting at least one stopper against the patient, the at least one stopper extending outward from the outer rim of the dental trap.
